(19) United States
(12) Patent Application Publication
(10) Pub. No.: US 2012/0163237 A1
(43) Pub. Date: Jun. 28, 2012

(54) APPARATUS AND METHOD FOR CONFIGURING PERSONAL SPACE WITH VIRTUAL SWITCH

(75) Inventor: Seong Soon JOO, Daejeon (KR)

(73) Assignee: Electronics and Telecommunications Research Institute, Daejeon (KR)

(21) Appl. No.: 13/335,622

(22) Filed: Dec. 22, 2011

(30) Foreign Application Priority Data
Dec. 23, 2010 (KR) 10-2010-0134095

(51) Int. Cl. H04W 76/02

(52) U.S. Cl. 370/254

(57) ABSTRACT

Disclosed are an apparatus and a method for configuring a personal space using a virtual switch and more particularly, an apparatus and a method for configuring a personal space providing an integrated service supporting a person by virtually integrating devices interworked with a heterogeneous communication network using a virtual switch. The exemplary embodiment of the present invention implements virtual switching by adding a configuration for interworking between devices connecting to different communication networks to an upper rank of a network layer as an adaptation layer. The exemplary embodiment of the present invention can configure an optimal environment in a personal space and thus, rapidly implement personal services.

### CROSS-REFERENCE TO RELATED APPLICATIONS

This application claims priority to and the benefit of Korean Patent Application NO. 10-2010-0134095 filed in the Korean Intellectual Property Office on Dec. 23, 2010, the entire contents of which are incorporated herein by reference.

### TECHNICAL FIELD

The present invention relates to an apparatus and a method for configuring a personal space. More particularly, the present invention relates to an apparatus and a method for configuring a personal space using a virtual switch.

### BACKGROUND

Today, a communication network to which devices may be connected has gradually diversified, such as a wireless sensor network (WSN), a wireless local area network (WLAN), Bluetooth, ZigBee, Wi-Fi, a 3G mobile communication, or the like. Typically, devices configuring a personal environment are vertically managed and operated according to a connection communication network. As an example, devices disposed in a predetermined space such as a ZigBee sensor node connected to the WSN, a media server connected to the WLAN, a sensor connected to a wired router, an M2M server or a personal terminal connected to the 3G mobile communication network, or the like, are vertically operated according to the connection communication network. Therefore, even though the devices according to the related art are physically disposed in a single space, the devices are operated by a network separated according to a management operator of a connection network and a core network and thus, cannot provide integrated services supporting a person.

### SUMMARY

The present invention has been made in an effort to provide an apparatus and a method for configuring a personal space that provide integrated services supporting a person by virtually integrating devices interworked with a heterogeneous communication network using a virtual switch.

An exemplary embodiment of the present invention provides a system for configuring a personal space, including: a device search unit that searches at least one second device interworked with a first device and a heterogeneous communication network; a virtual switching unit that virtually switches the first device and the searched second device with a virtual switch by using information on a layer located at an upper rank of a network layer; and a personal space configuration unit that configures a user personal space, including the first device, the searched second device, and the virtual switch.

The virtual switching unit may include: a device registration unit that registers the second device in a predetermined network based on the information on the second device; a device setting unit that processes a memory of the registered second device to be set as a virtual switching target device; and a switching unit that virtually switches the set second device to the first device. In addition, the device setting unit may process a stack of the registered second device.

The personal space configuration unit may include: a network connection unit that connects to a network associated with a user personal space by using a switching program added to the second device at the time of performing the virtual switching; an application program extraction unit that extracts application programs to be applied to the second device connected to the network in consideration of a profile for configuring the user personal space; and a space configuration unit that configures the user personal space using the extracted application programs.

The virtual switching unit may use a network adaptation layer for virtual switching as a layer located at the upper rank of the network layer.

The virtual switching unit may use, as the network adaptation layer, a converter layer for interworking a protocol between the first device and the second device, a translator layer for analyzing IDs and addresses of the second device, a virtual space switch layer for switching the virtual space associated with the interworking of the first device and the second device, and an application layer processing application programs associated with a user personal space configuration.

The virtual switching unit may further use, as the network adaptation layer, a virtual content switch layer for switching the virtual content to be provided to the second device from the first device and a network management layer managing a network for virtual switching.

The virtual switching unit may further include a device information collection unit that collects content information of the second device or environmental information associated with the second device as the information on the second device.

The device search unit may search the second device located within a predetermined distance from the first device or further search the device interworked with the first device and a homogeneous communication network.

Another exemplary embodiment of the present invention provides a method for configuring a personal space, including: searching at least one second device interworked with a first device and a heterogeneous communication network; virtually switching the first device and the searched second device with a virtual switch by using information on a layer located at an upper rank of a network layer; and configuring a user personal space, including the first device, the searched second device, and the virtual switch.

The virtual switching may include: registering the second device in a predetermined network based on the information on the second device; processing a memory of the registered second device to be set as a virtual switching target device; and virtually switching the set second device to the first device. In addition, the device setting unit may process a stack of the registered second device.

The configuring of the personal space may include: connecting to a network associated with a user personal space by using a switching program added to the second device at the time of performing the virtual switching; extracting application programs to be applied to the second device connected to the network in consideration of a profile for configuring the user personal space; and configuring the user personal space using the extracted application programs.

The virtual switching may use a network adaptation layer for virtual switching as a layer located at the upper rank of the network layer.

The virtual switching may use, as the network adaptation layer, a converter layer for interworking a protocol between the first device and the second device, a translator layer for analyzing IDs and addresses of the second device, a virtual space switch layer for switching the virtual space associated with the interworking of the first device and the second device, and an application layer processing application programs associated with a user personal space configuration.

The virtual switching may further use, as the network adaptation layer, a virtual content switch layer for switching the virtual content to be provided to the second device from the first device and a network management layer managing a network for virtual switching.

The virtual switching may further include collecting content information of the second device or environmental information associated with the second device as the information on the second device.

The searching of the device may search the second device located within a predetermined distance from the first device or further search the device interworked with the first device and a homogenous communication network.

According to the exemplary embodiments of the present invention, it is possible to provide the integrated services supporting a person by virtually integrating and interworking the devices interworked with the heterogeneous communication network using the virtual switch. In addition, it is possible to configure the optimal environment in the personal space, thereby rapidly implementing the personal services.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically showing an apparatus for configuring a personal space according to an exemplary embodiment of the present invention.

FIG. 2 is a block diagram showing in detail an internal configuration of the apparatus for configuring a personal space.

FIG. 3 is a conceptual diagram showing a personal space network with a virtual switching gateway according to the exemplary embodiment of the present invention.

FIG. 4 is a conceptual diagram showing a configuration of a virtual switch and a virtual switching network device configuring a virtual switching network.

FIG. 5 is a flow chart showing a method for configuring a personal space according to another exemplary embodiment of the present invention.

FIG. 6 is a flow chart showing a process of configuring the virtual switching network according to the exemplary embodiment of the present invention.

FIG. 7 is a conceptual diagram of a virtual switching network according to another exemplary embodiment of the present invention.

FIG. 8 is an exemplary flow chart of a service for configuring a personal space using the virtual switching network of FIG. 7.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

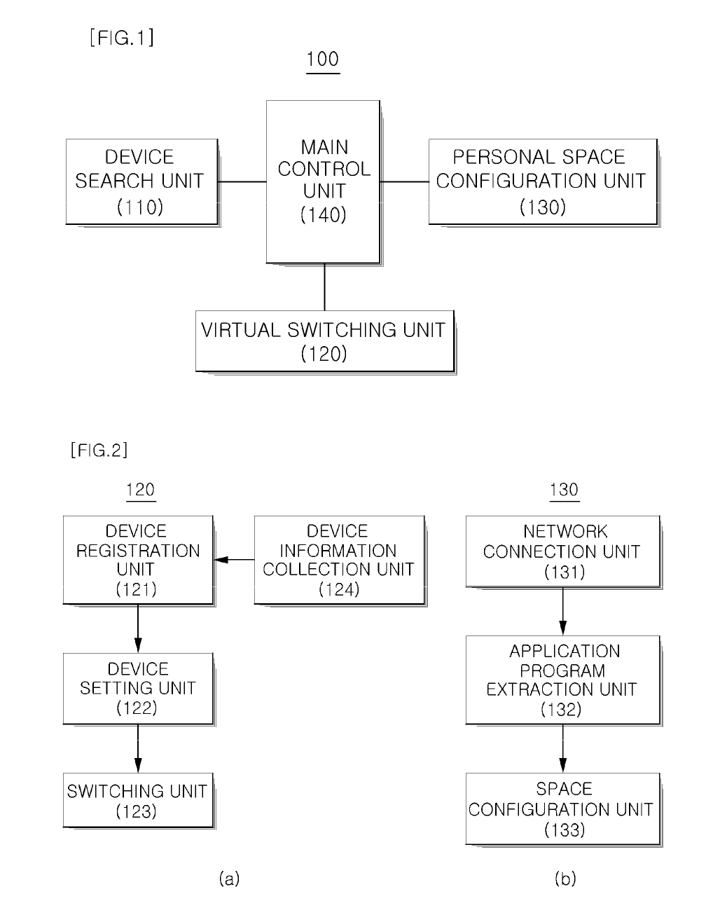

FIG. 1 is a block diagram schematically showing an apparatus for configuring a personal space according to an exemplary embodiment of the present invention. FIG. 2 is a block diagram showing in detail an internal configuration of the apparatus for configuring a personal space. Hereinafter, exemplary embodiments of the present invention will be described with reference to FIGS. 1 and 2. Referring to FIG. 1, an apparatus 100 for configuring a personal space includes a device search unit 110, a virtual switching unit 120, a personal space configuration unit 130, and a main control unit 140.

The device search unit 110 serves to search at least one second device interworked with a first device and a heterogeneous communication network. The device search unit 110 searches the second device that is disposed within a predetermined distance from the first device. In addition, the device search unit 110 may further search the device interworked with the first device and a homogeneous communication network. Searching the device disposed within the predetermined distance by the device search unit 110 is to provide a position based on personal service to a user. Therefore, the predetermined distance may be set to be, for example, 10 m to 100 m. However, in the exemplary embodiment of the present invention, the predetermined distance is not particularly limited thereto. In the exemplary embodiment of the present invention, the first device corresponds to the user device to which the user connects. However, the first device is not particularly limited to the user device.

The virtual switching unit 120 serves to virtually switch the first device and the searched second device by the virtual switch using a layer located at an upper rank of a network layer as a layer added for interworking between the devices connecting to different communication networks. The virtual switching unit 120 may be implemented so as to be interworked with the virtual switch. The virtual switch may be provided in the user device and may be separately provided from the user device. In this configuration, the network layer means a third layer that selects a communication path for transmitting data to a third party in an open systems interconnection (OSI) 7 layer or manages addresses within the communication path.

The virtual switching unit 120 uses a network adaptation layer for the virtual switching as a layer located at the upper rank of the network layer. In detail, the virtual switching unit 120 uses, as the network adaptation layer, a converter layer for interworking a protocol between the first device and the second device, a translator layer for analyzing IDs and addresses of the second device, a virtual space switch layer for switching the virtual space associated with the interworking of the first device and the second device, and an application layer processing application programs associated with a user personal space configuration. The virtual switching unit 120 may further use a virtual content switch layer for switching a virtual content to be provided from the first device to the second device and a network management layer managing the network for the virtual switching, as the network adaptation layer.

The virtual switching unit 120 may include a device registration unit 121, a device setting unit 122, and a switching unit 123 as shown in FIG. 2 (a). The device registration unit 121 serves to allow a device subscribed in the personal space service to register environmental information of the device in the virtual switch of the predetermined network or to register the environmental information of the device in the virtual switch of the predetermined network based on information on the searched second device. In this configuration, the predetermined network may be, for example, the virtual personal space network for the user personal space configuration. The device setting unit 122 serves to process a memory of the registered second device to be se as a virtual switching target device. The device setting unit 122 manages the memory embedded in the second device as a protocol interworking converter layer required to set the virtual switching target device, an ID/address translator layer of the device, a virtual space switch layer, and a region for user personal space configuration application programs. The switching unit 123 serves to virtually switch the set second device to the first device.

The virtual switching unit 120 may further include a device information collection unit 124. The device information collection unit 124 serves to collect content information of the second device or environmental information associated with the second device as the information on the second device. The content information of the second device may correspond to, for example, specifications of the second device as information indicating characteristics of the second device. The environmental information associated with the second device includes information on the communication network to which the second device is connected.

The personal space configuration unit 130 serves to configure the user personal space, including the first device, the searched second device, and the virtual switch. In the exemplary embodiment of the present invention, configuring the user personal space is to provide the integrated services supporting a person according to the position, and for example, to provide the personal service to the user.

The personal space configuration unit 130 may include a network connection unit 131, an application program extraction unit 132, and a space configuration unit 133, as shown in FIG. 2 (b). The network connection unit 131 serves to use the switching program added to the second device at the time of performing the virtual switching to be connected to the network associated with the user personal space. The application program extraction unit 132 serves to extract the application programs to be applied to the second device connected to the network, in consideration of a profile for the user personal space configuration. The profile for the user personal space configuration may include various classes necessary for the personal space configuration (e.g. division identifier for each area, connection network characteristics, information capability, device capability, user service type, various classes of the device defined by ISO standard, or the like) and may also include contents previously consented in connection with the virtual environment between the devices. The application programs extracted by the application program extraction unit 132 are application programs considering the characteristics of the second device. The space configuration unit 133 serves to configure the user personal space by using the extracted application programs.

The main control unit 140 serves to control all the operations of each unit configuring the apparatus 100 for configuring a personal space.

The apparatus 100 for configuring a personal space virtually integrates the devices interworked with the heterogeneous communication network by using the virtual switch to configure the personal space. In this case, the virtual switch virtually interworks adjacent devices for configuring the personal space, regardless of the existing connection network.

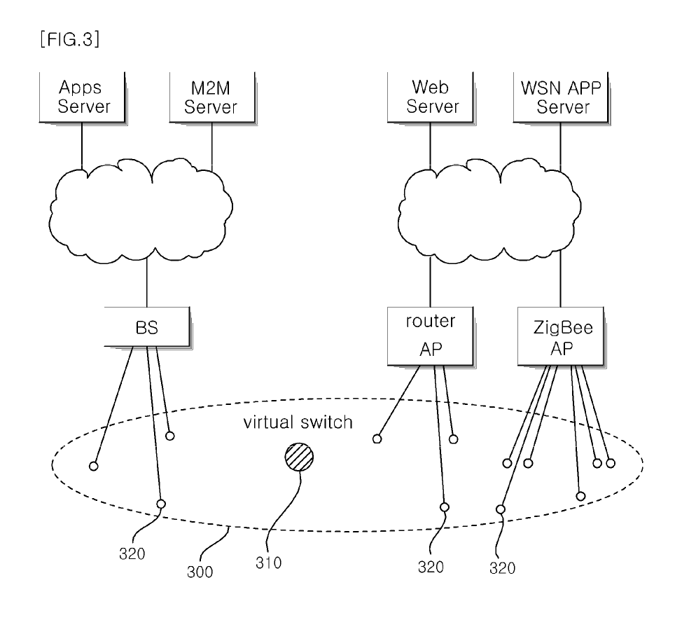

FIG. 3 shows the personal space network by the virtual switching gateway according to the exemplary embodiment of the present invention. Describing the virtual switching apparatus for configuring a personal space with reference to FIG. 3, when a virtual switching gateway 310 in the personal device type is added to a personal space 300, the virtual switching apparatus searches the device 320 capable of configuring the personal space to load the related program using the existing connection network so as to perform the virtual switching, such that the virtual switching apparatus adds functions to the personal space switching network device and then, connects to the virtual switching network.

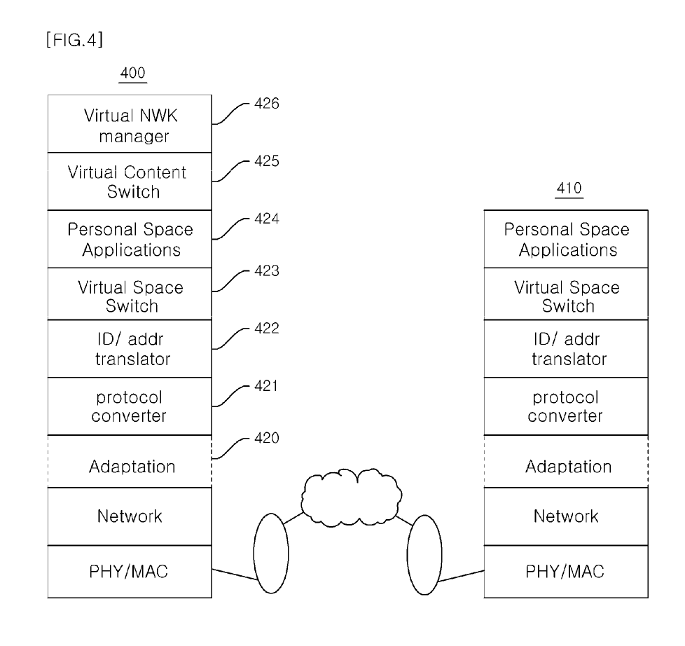

FIG. 4 shows a configuration of a virtual switch 400 and a virtual switching network device 410 configuring a virtual switching network. Both of the virtual switch 400 and the virtual switching network device 410 are applied with a PHY/MAC and a network protocol of the existing connection network. The virtual switch 400 and the virtual switching network device 410 add to the virtual switching network function on a layer located at an upper rank of these layers using the adaptation layer 420 for the virtual switching network. The network adaptation layer 420 may be configured to include a protocol converter 421, an ID/address translator 422, a virtual space switch 423, personal space applications 424, a virtual content switch 425, a virtual NWK manager 426, and the like. The protocol converter 421 is a concept corresponding to the converter layer of FIG. 1 and the ID/address translator 422 is a concept corresponding to the translator layer of FIG. 1.

In addition, the virtual space switch 423 is a concept corresponding to the virtual space switch layer of FIG. 1 and the personal space applications 424 are a concept corresponding to the application layer of FIG. 1. In addition, the virtual content switch 425 is a concept corresponding to the virtual content switch layer of FIG. 1 and the personal switching network management 426 is a concept corresponding to the network management layer of FIG. 1.

The virtual switch 400 may be provided with all the layers 421 to 426 configuring the network adaptation layer 420 but the virtual switching network device 410 may be provided with the remaining layers 421 to 424 other than the virtual content switch 425 and the virtual switching network management 426.

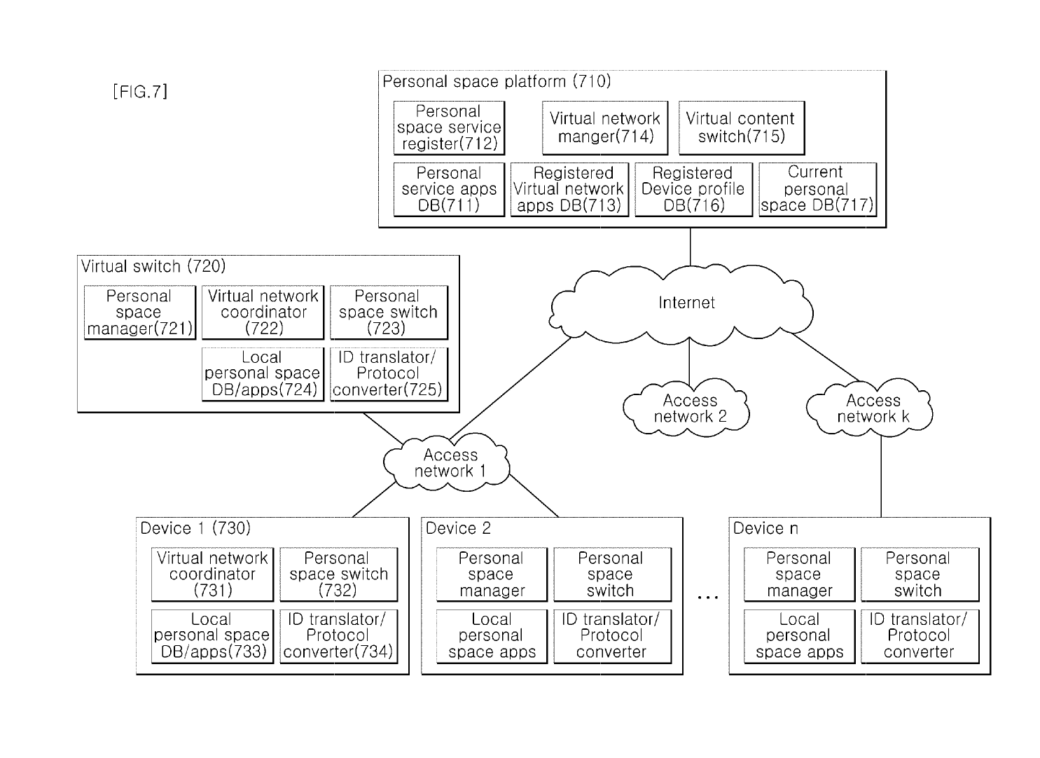

FIG. 7 shows a virtual switching network according to another exemplary embodiment of the present invention. The personal space network is configured to include a personal space platform 710 that registers the personal space network service and maintains and provides service related information, a personal space virtual switch 720 that configures the personal space network and intervenes the personal space service, and a device 730 that implements the personal space service. The personal space virtual switch 720 may be provided in a type integrated with the device or may be disposed on the personal space service platform 710.

The personal space service platform 710 is configured to include a personal space service register 712 that registers application services input from the service provider and manages personal service apps DB 711, a registered virtual network DB 713 that is registered from the service provider at each specific location, a virtual network manager 714 that manages a profile DB of devices located at each location, and a virtual content switch 715 that supports the control and data exchange of the personal space service. The registered virtual network DB 713 is configured to include information such as a location identifier representing geographical positions for each specific location, an address system of the connection network installed, a connection address, a communication class, a bandwidth, a communication range, QoS, or the like.

A registered device profile DB 716 is configured to include information such as a type of a connection network, an identifier within the connection network, information processing capability (sensing, data, video, audio, bit rate, data generation period), processing capability (power supply, processor, memory capability), or the like. Meanwhile, a current personal space DB 717 stores information associated with a currently operating personal space virtual network DB in the registered personal space virtual network DB.

The personal space virtual switch 720 is configured to include a virtual network coordinator 722 that performs a device search within the corresponding space for configuring the virtual network of the specific location, a provision of a protocol software for configuring the virtual network to the device, the virtual network configuration management, or the like, and a personal space switch 723 that provides personal space service software to the device and intervenes the control or the data exchange between the devices for performing the personal space service or provides a contents switch function of the service platform. The virtual network coordinator 722 is interworked with a local personal space DB/apps 724 to provide the protocol software for configuring the virtual network to the device and is interworked with the personal space manager 721 to perform the virtual network configuration management function. Meanwhile, an ID translator/protocol converter 725 is a concept corresponding to the protocol converter 421 and the ID/address translator 422 of FIG. 4.

The personal space virtual switch 720 uses the position identifier at the time of moving to the specific location to request the virtual network information of the corresponding area to the platform and obtain the profile information of the registered device. The connection to the corresponding device through the connection network is tried according to the characteristics of the device and the virtual network configuration is completed by providing a protocol stack required for the replying device.

The personal space virtual switch 720 provides its own application service software to the device or requests a platform to receive software according to the type of the personal space service, thereby completing the personal space application service configuration.

The control and data exchange between the devices are performed by the personal space virtual switch 720 according to the progress of the personal space service and are transferred through the personal space virtual switch 720 when the content switching of the platform according to the type of the personal space service is required

The device 730 is configured to include a personal space manager 731 that is registered in the personal space service and responds to the virtual network configuration and a personal space switch 732 that receives the personal space service software or transfers the control and data that are generated during the personal space service. Meanwhile, a local personal space application 733 and an ID translator/protocol converter 734 each perform the same function as a local personal space DB 724 and the ID translator/protocol converter 725.

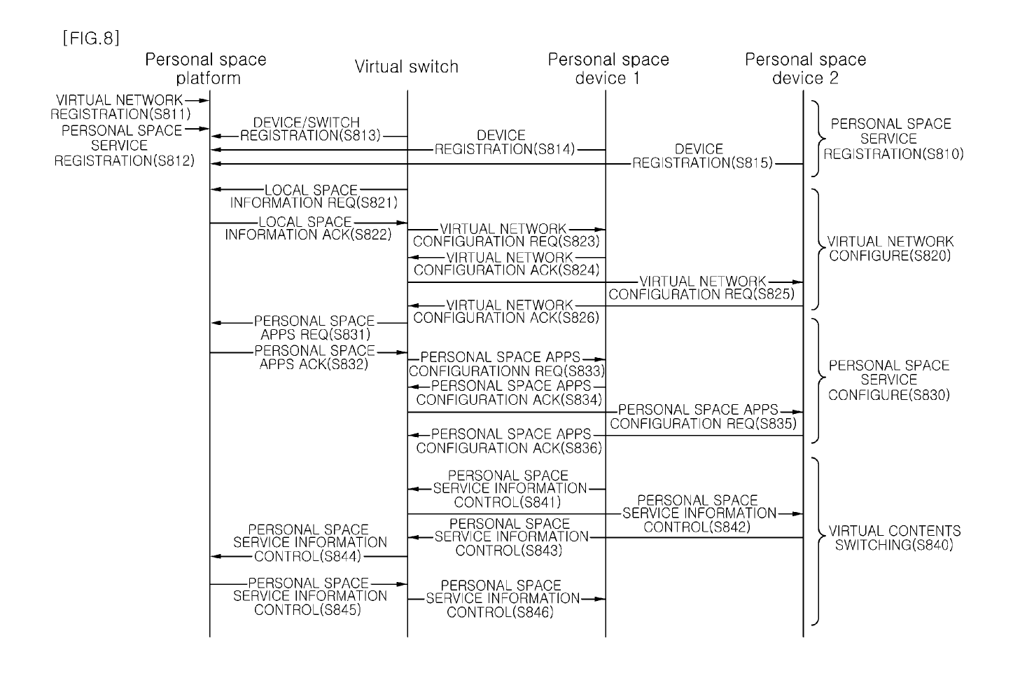

FIG. 8 is an exemplary flow chart of a service for configuring a personal space using the virtual switching network of FIG. 7. The service for configuring a personal space according to the exemplary embodiment of the present invention is configured to include a personal space service registration process (S810), a virtual network configuration process (S820), a personal space service configuration process (S830), a virtual content switching process (S840), and the like. The service for configuring a personal space according to the exemplary embodiment of the present invention will be described under the assumption that there are two devices. However, in the exemplary embodiment of the present invention, the number of devices is not limited thereto.

The personal space service registration process (S810) is configured in detail as follows. First, the personal space platform performs the virtual network registration of the selected device (S811). Thereafter, the personal space platform performs the personal space service registration (S812). Thereafter, the virtual switch, a personal space device 1, a personal space device 2, and the like, are registered by the switch or the device through the personal space platform (S813 to S815).

The virtual network configuration process (S820) is configured in detail as follows. First, the virtual switch requests local space information to the personal space platform (S821). Then, the personal space platform performs the reply thereto (S822). Thereafter, the virtual switch requests the virtual network configuration to the first device and the second device (S823 and S825). Then, the first device and the second device reply thereto (S824 and S826). The virtual network configuration request (S823) and the virtual network configuration reply (S824) to the first device may be first performed and then, the virtual network configuration request (S825) and the virtual network configuration reply (S826) to the second device may be performed.

The personal space service configuration process (S830) is configured in detail as follows. First, the virtual switch requests the personal space application software to the personal space platform (S831). Then, the personal space platform performs the reply thereto (S832). Thereafter, the virtual switch requests the personal space application software configuration to the first device and the second device (S833 and S835). Then, the first device and the second device reply thereto (S834 and S836). The personal space application software configuration request (S833) and the personal space application software configuration reply (S834) to the first device may be first performed and then, the personal space application software configuration request (S835) and the personal space application software configuration reply (S836) to the second device may be performed.

The virtual content switching process (S840) is configured in detail as follows. First, the first device requests the personal space service information control to the virtual switch (S841). Thereafter, the virtual switch queries to the second device whether the personal space service information control is required (S842). If the second device replies that the control is required (S843), the virtual switch requests the personal space service information control to the personal space platform (S844). If the personal space platform replies thereto (S845), the virtual switch performs the personal space service information control for the first device (S846). In this case, the personal space service information control for the second device is performed together.

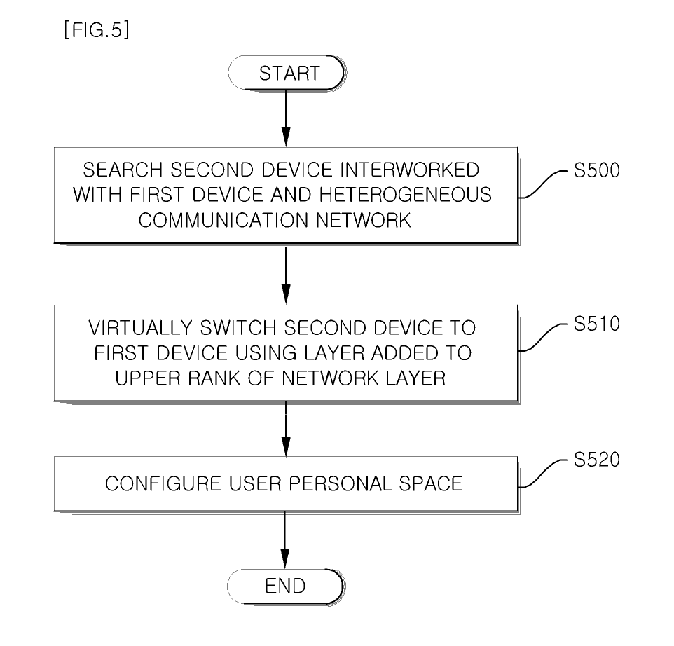

Next, a method for configuring a personal space of the apparatus 100 for configuring a personal space will be described. FIG. 5 is a flow chart showing a method for configuring a personal space according to an exemplary embodiment of the present invention. The following description will be made with reference to FIG. 5.

First, at least one second device interworked with the first device and a heterogeneous communication network is searched (device search process (S500)). The device search process (S500) searches the second device that is disposed within a predetermined distance from the first device. The device search process (S500) may further search the device interworked with the first device and the homogeneous communication network.

Thereafter, the first device and the searched second device are virtually switched by the virtual switch by using the information on the layer located at the upper rank of the network layer as a layer added for interworking between the devices connecting to different communication networks (virtual switching process (S510)). Considering the above description, the virtual switching process (S510) may include the device registration process, the device setting process, and the switching process. The device registration process is a process of registering the second device in the predetermined network based on the information on the second device. The device setting process is a process that processes the memory of the registered second device to be set as the virtual switching target device. In particular, the device setting process processes a stack region of the registered second device.

The switching process is a process that virtually switches the set second device to the first device. Meanwhile, the virtual switching process (S510) may further include the device information collection process. The device information collection process is a process that collects the content information of the second device or the environmental information associated with the second device as the information on the second device. In the exemplary embodiment of the present invention, the device information collection process is performed prior to performing the device registration process.

The virtual switching process (S510) uses the network adaptation layer for the virtual switching as the layer located at the upper rank of the network layer. In detail, the virtual switching process (S510) uses, as the network adaptation layer, the converter layer for interworking a protocol between the first device and the second device, the translator layer for analyzing IDs and addresses of the second device, the virtual space switch layer for switching the virtual space associated with the interworking of the first device and the second device, and the application layer processing application programs associated with the user personal space configuration. The virtual switching process (S510) may further use, as the network adaptation layer, a virtual content switch layer for switching virtual contents to be provided from the first device to the second device and a network management layer managing the network for the virtual switching, as the network adaptation layer.

Thereafter, the user personal space is formed, including the first device, the searched second device, and the virtual switch (personal space configuration process (S520)). Considering this, the personal space configuration process (S520) may include the network connection process, the application program extraction process, and the space configuration process. The network connection process is a process that uses the switching program added to the second device at the time of performing the virtual switching to be connected to the network associated with the user personal space. The application program extraction process is a process that extracts the application programs to be applied to the second device connected to the network, in consideration of the profile for the user personal space configuration. The space configuration process is a process that uses the extracted application programs to configure the user personal space.

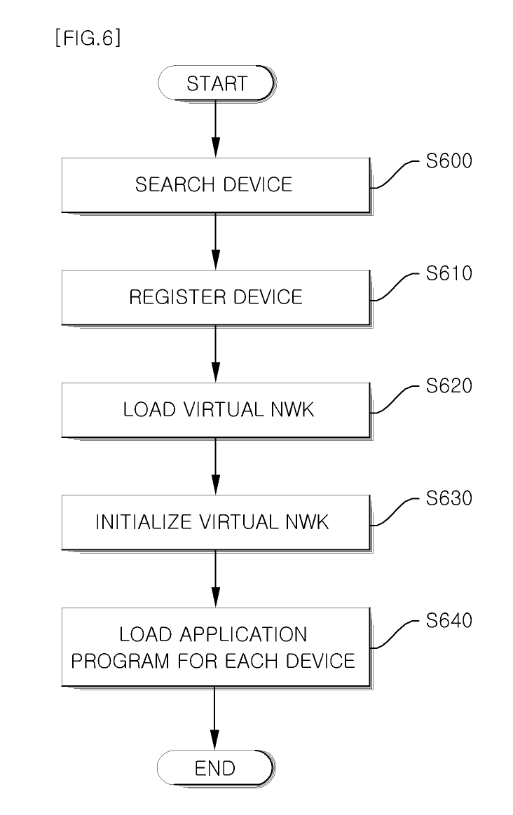

Next, the virtual switching network configuration will be described with reference to the exemplary embodiment of the present invention. FIG. 6 shows a process of configuring the virtual switching network according to the exemplary embodiment of the present invention. Referring to FIG. 6, the virtual switching network configuration may include a first process (S600) to a fifth process (S640). The first process (S600) is device searching that allows the virtual switching gateway to search the device capable of configuring the personal space.

The second process (S610) is device registration that collects the device characteristics and the information needed to adapt the environment to register the corresponding device in the virtual switching network. The third process (S620) is virtual NWK loading that loads a stack needed for adding to the virtual switching network terminal. The fourth process (S630) is virtual NWK initialization that initially connects to virtual switching network by the virtual switching program applied to the device. The fifth process (S640) is personal APPS loading that loads additional application program for each characteristic of the device according to the personal space configuration profile.

The exemplary embodiments of the present invention relate to the apparatus and the method for configuring the personal space using the virtual switch and can build the network platform for configuring the personal space network, in particular, the radio sensor network platform.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for configuring a personal space, comprising:
a device search unit that searches at least one second device interworked with a first device and a heterogeneous communication network;
a virtual switching unit that virtually switches the first device and the searched second device with a virtual switch by using information on a layer located at an upper rank of a network layer as a layer added for interworking between devices connecting to different communication networks; and
a personal space configuration unit that configures a user personal space, including the first device, the searched second device, and the virtual switch.

2. The apparatus of claim 1, wherein the virtual switching unit includes:
a device registration unit that registers the second device in a predetermined network based on the information on the second device;
a device setting unit that processes a memory of the registered second device to be set as a virtual switching target device; and
a switching unit that virtually switches the set second device to the first device.

3. The apparatus of claim 1, wherein the personal space configuration unit includes:
a network connection unit that connects to a network associated with a user personal space by using a switching program added to the second device at the time of performing the virtual switching;
an application program extraction unit that extracts application programs to be applied to the second device connected to the network in consideration of a profile for configuring the user personal space; and
a space configuration unit that configures the user personal space using the extracted application programs.

4. The apparatus of claim 1, wherein the virtual switching unit uses a network adaptation layer for virtual switching as a layer located at the upper rank of the network layer.

5. The apparatus of claim 4, wherein the virtual switching unit uses, as the network adaptation layer, a converter layer for interworking a protocol between the first device and the second device, a translator layer for analyzing IDs and addresses of the second device, a virtual space switch layer for switching the virtual space associated with the interworking of the first device and the second device, and an application layer processing application programs associated with a user personal space configuration.

6. The apparatus of claim 5, wherein the virtual switching unit further uses, as the network adaptation layer, a virtual content switch layer for switching the virtual content to be provided to the second device from the first device and a network management layer managing a network for virtual switching.

7. The apparatus of claim 2, wherein the virtual switching unit further includes a device information collection unit that collects content information of the second device and environmental information associated with the second device as the information on the second device.

8. The apparatus of claim 2, wherein the device setting unit processes a stack region of the registered second device.

9. The apparatus of claim 1, wherein the device search unit searches the second device located within a predetermined distance from the first device or further searches the device interworked with the first device and a homogeneous communication network.

10. A method for configuring a personal space, comprising:
searching at least one second device interworked with a first device and a heterogeneous communication network;
virtually switching the first device and the searched second device with a virtual switch by using information on a layer located at an upper rank of a network layer as a layer added for interworking between devices connecting to different communication networks; and
configuring a user personal space, including the first device, the searched second device, and the virtual switch.

11. The method of claim 10, wherein the virtual switching includes:
registering the second device in a predetermined network based on the information on the second device;
processing a memory of the registered second device to be set as a virtual switching target device; and
virtually switching the set second device to the first device.

12. The method of claim 10, wherein the configuring of the personal space includes:
connecting to a network associated with a user personal space by using a switching program added to the second device at the time of performing the virtual switching;
extracting application programs to be applied to the second device connected to the network in consideration of a profile for configuring the user personal space; and
configuring the user personal space using the extracted application programs.

13. The method of claim 10, wherein the virtual switching uses a network adaptation layer for virtual switching as a layer located at the upper rank of the network layer.

14. The method of claim 13, wherein the virtual switching uses, as the network adaptation layer, a converter layer for interworking a protocol between the first device and the second device, a translator layer for analyzing IDs and addresses of the second device, a virtual space switch layer for switching the virtual space associated with the interworking of the first device and the second device, and an application layer processing application programs associated with a user personal space configuration.

15. The method of claim 14, wherein the virtual switching further uses, as the network adaptation layer, a virtual content switch layer for switching the virtual content to be provided to the second device from the first device and a network management layer managing a network for virtual switching.

16. The method of claim 11, wherein the virtual switching further includes collecting content information of the second device and environmental information associated with the second device as the information on the second device.

17. The method of claim 11, wherein the setting of the device processes a stack region of the registered second device.

18. The method of claim 10, wherein the searching of the device searches the second device located within a predetermined distance from the first device or further searches the device interworked with the first device and a homogeneous communication network.
